(19) United States
(12) Patent Application Publication
(10) Pub. No.: US 2015/0158116 A1
(43) Pub. Date: Jun. 11, 2015

(54) METHOD AND APPARATUS FOR INTERNALLY MARKING A SUBSTRATE HAVING A ROUGH SURFACE

(71) Applicant: ELECTRO SCIENTIFIC INDUSTRIES, INC., Portland, OR (US)

(72) Inventors: Haibin Zhang, Portland, OR (US); Mathew Rekow, Santa Cruz, CA (US); Chuan Yang, Beaverton, OR (US); Michael J. Darwin, Portland, OR (US)

(21) Appl. No.: 14/558,324

(22) Filed: Dec. 2, 2014

Related U.S. Application Data
(60) Provisional application No. 61/912,192, filed on Dec. 5, 2013.

(51) Int. Cl. B23K 26/00; B23K 26/30

(52) U.S. Cl. CPC B23K 26/009; B23K 26/0054; B23K 26/421; B23K 26/0039; B23K 26/0051

(57) ABSTRACT

A method for laser processing provides a coating material (130) applied to a rough surface (42) of a substrate (44) to mitigate adverse optical effects that would be caused by roughness of the surface (42). Laser pulses (52) of the laser output of suitable parameters can be directed and focused to internally mark the substrate (44) material without damaging the rough surface (42) after passing through the coating material (130).

### RELATED APPLICATIONS

This application is a Non-Provisional application of U.S. Provisional Patent Application No. 61/912,192, which was filed on 5 Dec. 2013, the contents of which are herein incorporated by reference in their entirety for all purposes.

### COPYRIGHT NOTICE

© 2014 Electro Scientific Industries, Inc. A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR §1.71(d).

### TECHNICAL FIELD

This application relates to laser processing of a substrate and, in particular, to a method and apparatus for internally marking a substrate having a rough surface.

### BACKGROUND

Marketed products commonly require some type of marking on the product for commercial, regulatory, cosmetic or functional purposes. Desirable attributes for marking include consistent appearance, durability, and ease of application. Appearance refers to the ability to reliably and repeatably render a mark with a selected shape, color, and optical density. Durability is the quality of remaining unchanged in spite of abrasion to the marked surface. Ease of application refers to the cost in materials, time, and resources of producing a mark including programmability. Programmability refers to the ability to program the marking device with a new pattern to be marked by changing software as opposed to changing hardware such as screens or masks. Lasers are conventionally used to mark or scribe the surfaces of a variety of materials.

### SUMMARY

This summary is provided to introduce a selection of concepts in a simplified form that are further described in the detailed description of the exemplary embodiments. This summary is not intended to identify key or essential inventive concepts of the claimed subject matter, nor is it intended for limiting the scope of the claimed subject matter.

In some embodiments, a method for laser processing a substrate having opposing first and second surfaces of substrate material and having a core of substrate material between the first and second surfaces, comprises: providing the substrate, wherein at least one of the first and second surfaces has a rough surface with rough surface texture, wherein the core of substrate material has a substrate refractive index, wherein a coating material has been applied to the rough surface, and wherein the coating material has a coating refractive index that is optically compatible with the substrate refractive index of the substrate material; generating laser output having laser processing parameters suitable for marking the core of the substrate material without damaging the rough surface after passing through the coating material, wherein the laser processing parameters include a laser wavelength; focusing laser pulses of the laser output to have a minimum beam waist at a focal point; and directing the laser output through the coating material and through the rough surface so that the focal point of the laser pulses is positioned within the core of the substrate material to mark the core of the substrate without damaging the rough surface, wherein the coating material is at least partly optically transmissive to the laser wavelength.

In some alternative, additional, or cumulative embodiments, the substrate is partly optically transmissive to the laser wavelength.

In some alternative, additional, or cumulative embodiments, the substrate comprises a wafer material.

In some alternative, additional, or cumulative embodiments, the substrate comprises a sapphire wafer, a diamond wafer, or a silicon wafer.

In some alternative, additional, or cumulative embodiments, the substrate comprises a sapphire wafer.

In some alternative, additional, or cumulative embodiments, the substrate comprises an unpolished wafer.

In some alternative, additional, or cumulative embodiments, the substrate material comprises diamond.

In some alternative, additional, or cumulative embodiments, the substrate material comprises plastic.

In some alternative, additional, or cumulative embodiments, the laser wavelength comprises a wavelength between 200 nm and 3000 nm.

In some alternative, additional, or cumulative embodiments, the laser wavelength comprises an IR wavelength.

In some alternative, additional, or cumulative embodiments, the laser wavelength comprises a 1064 nm wavelength.

In some alternative, additional, or cumulative embodiments, the laser processing parameters comprise a pulsewidth of between 1 fs and 500 ns.

In some alternative, additional, or cumulative embodiments, the laser processing parameters comprise a pulsewidth of between 500 fs and 10 ns.

In some alternative, additional, or cumulative embodiments, the laser processing parameters comprise a pulsewidth of between 1 ps and 100 ps.

In some alternative, additional, or cumulative embodiments, the laser processing parameters comprise a pulsewidth of between 1 ps and 25 ps.

In some alternative, additional, or cumulative embodiments, the laser processing parameters comprise a spot size or beam waist of between 1 micron and 50 microns.

In some alternative, additional, or cumulative embodiments, the laser processing parameters comprise a spot size or beam waist of between 1 micron and 25 microns.

In some alternative, additional, or cumulative embodiments, the laser processing parameters comprise a spot size or beam waist of between 1 micron and 5 microns.

In some alternative, additional, or cumulative embodiments, the coating material comprises a fluid or a gel.

In some alternative, additional, or cumulative embodiments, the coating material comprises an oil.

In some alternative, additional, or cumulative embodiments, the coating material has a boiling point that is greater than 180 degrees Celsius (such as at 760 mm Hg).

In some alternative, additional, or cumulative embodiments, the coating refractive index is within 2 of the refractive index of the substrate refractive index (such as at 25 degrees Celsius).

In some alternative, additional, or cumulative embodiments, the coating refractive index is within 1 of the refractive index of the substrate refractive index.

In some alternative, additional, or cumulative embodiments, the coating refractive index is within 0.5 of the refractive index of the substrate refractive index.

In some alternative, additional, or cumulative embodiments, the coating refractive index is within 0.2 of the refractive index of the substrate refractive index.

In some alternative, additional, or cumulative embodiments, the coating refractive index is between 1.2 and 2.5.

In some alternative, additional, or cumulative embodiments, the coating refractive index is between 1.5 and 2.2.

In some alternative, additional, or cumulative embodiments, the coating refractive index is between 1.7 and 2.0.

In some alternative, additional, or cumulative embodiments, the coating refractive index is between 1.75 and 1.85.

In some alternative, additional, or cumulative embodiments, the coating material has a density of between 2 and 5 g/cc (such as at 25 degrees Celsius).

In some alternative, additional, or cumulative embodiments, the coating material has a density of between 2.5 and 4 g/cc.

In some alternative, additional, or cumulative embodiments, the coating material has a density of between 3 and 3.5 g/cc.

In some alternative, additional, or cumulative embodiments, the coating material comprises methylene iodide.

In some alternative, additional, or cumulative embodiments, the coating material comprises gem refractometer liquid.

In some alternative, additional, or cumulative embodiments, the coating material maintains fluidic properties during laser processing.

In some alternative, additional, or cumulative embodiments, the coating material comprises a leveling composition.

In some alternative, additional, or cumulative embodiments, the coating material is easy to remove from the rough surface after laser processing.

In some alternative, additional, or cumulative embodiments, the method further comprises placing a cover over the coating after the step applying a coating material and before the step of directing the laser output.

In some alternative, additional, or cumulative embodiments, the cover is transparent to the laser wavelength.

In some alternative, additional, or cumulative embodiments, the cover comprises the substrate material.

In some alternative, additional, or cumulative embodiments, the cover comprises a smooth, cover surface that is nonreflective at the wavelength.

In some alternative, additional, or cumulative embodiments, the cover comprises a glass.

In some alternative, additional, or cumulative embodiments, the cover comprises a sapphire, diamond, silicon, or plastic.

In some alternative, additional, or cumulative embodiments, the cover has a cover refractive index that is within 2 of the refractive index of the substrate refractive index (such as at 25 degrees Celsius).

In some alternative, additional, or cumulative embodiments, the cover has a cover refractive index that is within 1 of the refractive index of the substrate refractive index.

In some alternative, additional, or cumulative embodiments, the cover has a cover refractive index that is within 0.5 of the refractive index of the substrate refractive index.

In some alternative, additional, or cumulative embodiments, the cover has a cover refractive index that is within 0.2 of the refractive index of the substrate refractive index.

In some alternative, additional, or cumulative embodiments, the cover has a cover refractive index that is between 1.2 and 2.5.

In some alternative, additional, or cumulative embodiments, the cover has a cover refractive index that is between 1.5 and 2.2.

In some alternative, additional, or cumulative embodiments, the cover has a cover refractive index that is between 1.7 and 2.0.

In some alternative, additional, or cumulative embodiments, the cover has a cover refractive index that is between 1.75 and 1.85.

In some alternative, additional, or cumulative embodiments, the core has a core thickness and the cover has a cover thickness that is shorter than the core thickness.

In some alternative, additional, or cumulative embodiments, the cover is shaped to contain the coating material on the rough surface of the substrate.

In some alternative, additional, or cumulative embodiments, the coating material has an upper surface and wherein the cover is shaped to flatten the upper surface of the coating material.

In some alternative, additional, or cumulative embodiments, the rough surface texture of the rough surface has a native state that causes scattering of the laser output, and wherein the coating material reduces the scattering of the laser output that would be caused by the native state of the rough surface in the absence of the coating material.

In some alternative, additional, or cumulative embodiments, the laser processing parameters include output power, and wherein the rough surface texture of the rough surface has a native state that attenuates the output power, and wherein the coating material reduces attenuation of the output power that would be caused by the native state of the rough surface texture in the absence of the coating material.

In some alternative, additional, or cumulative embodiments, the rough surface texture of the rough surface has a native state that interferes with formation of the beam waist at a predetermined size, and wherein the coating material reduces interference with the formation of the beam waist at the predetermined size that would be caused by the native state of the rough surface texture in the absence of the coating material.

In some alternative, additional, or cumulative embodiments, the rough surface texture of the rough surface has a native state that causes wavefront distortion of the laser output, and wherein the coating material reduces the wavefront distortion of the laser output that would be caused by the native state of the rough surface in the absence of the coating material.

In some alternative, additional, or cumulative embodiments, the substrate refractive index is between 1.2 and 2.5.

In some alternative, additional, or cumulative embodiments, the substrate refractive index is between 1.5 and 2.2.

In some alternative, additional, or cumulative embodiments, the substrate refractive index is between 1.7 and 2.0.

In some alternative, additional, or cumulative embodiments, the substrate refractive index is between 1.75 and 1.85.

In some alternative, additional, or cumulative embodiments, the substrate is a wafer cut from an ingot.

In some alternative, additional, or cumulative embodiments, the substrate is a wafer cut from an ingot by a diamond saw.

In some alternative, additional, or cumulative embodiments, the substrate is a wafer cut from an ingot to establish the rough surface in its native state.

In some alternative, additional, or cumulative embodiments, the coating material can be cleaned from the rough surface by acetone, carbon tetrachloride, ethyl ether, methylene chloride, toluene, xylene, or a combination thereof.

In some alternative, additional, or cumulative embodiments, the coating material can be cleaned from the rough surface by water.

In some alternative, additional, or cumulative embodiments, the coating material can be cleaned from the rough surface by alcohol.

It will be appreciated that the cumulative embodiments can also selectively omit any number of the preceding or following embodiments.

Additional aspects and advantages will be apparent from the following detailed description of preferred embodiments, which proceeds with reference to the accompanying drawings.

### BRIEF DESCRIPTION OF THE DRAWINGS

FIG. 1 is simplified and partly schematic perspective view of some components of an exemplary laser micromachining system suitable for producing the spot of a modified 2DID code.

FIG. 2 shows a diagram of a laser pulse focal spot and its beam waist.

FIG. 3 is a cross sectional side view of a wafer substrate, such as a sapphire wafer, having a rough surface covered by a coating material and a cover.

### DETAILED DESCRIPTION OF PREFERRED EMBODIMENTS

Example embodiments are described below with reference to the accompanying drawings. Many different forms and embodiments are possible without deviating from the spirit and teachings of this disclosure and so this disclosure should not be construed as limited to the example embodiments set forth herein. Rather, these example embodiments are provided so that this disclosure will be thorough and complete, and will convey the scope of the disclosure to those skilled in the art. In the drawings, the sizes and relative sizes of components may be exaggerated for clarity. The terminology used herein is for the purpose of describing particular example embodiments only and is not intended to be limiting. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Unless otherwise specified, a range of values, when recited, includes both the upper and lower limits of the range, as well as any sub-ranges therebetween.

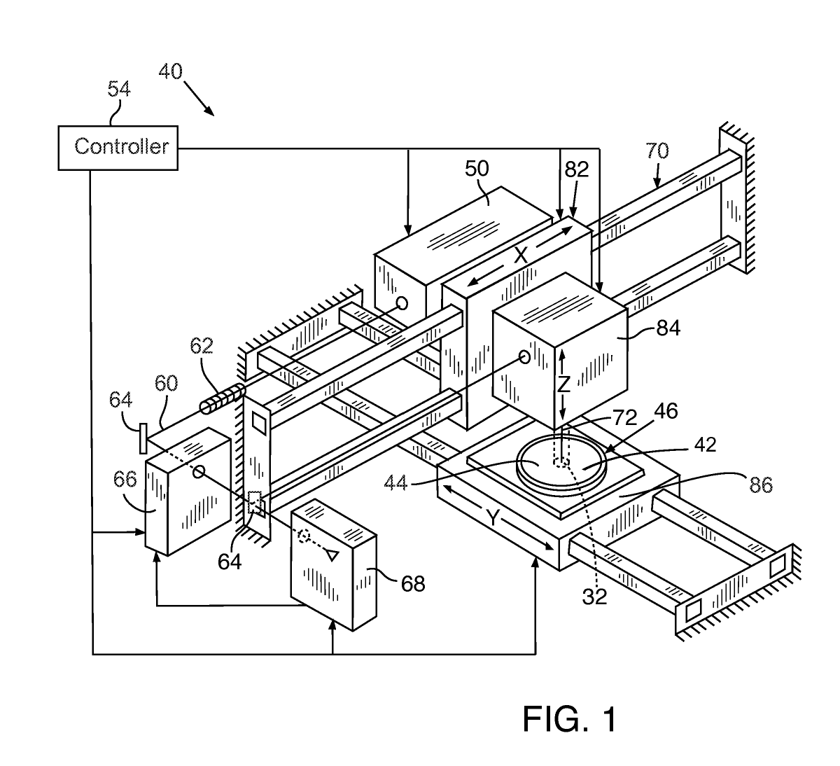

FIG. 1 is simplified and partly schematic perspective view of some components of an exemplary laser micromachining system 40 suitable for producing one or more marking spots 32 of a laser mark on or within a substrate 44 of a workpiece 46. With reference to FIG. 1, lasers have been employed to mark workpieces 46, such as wafers 100 (FIG. 3) or other semiconductor industry material substrates 44. Exemplary substrate materials include ceramics, glasses, plastics, and metals, or combinations thereof. Exemplary materials may be crystalline or noncrystalline. Exemplary materials may be natural or synthetic.

For example, laser micromachining systems can make appropriately sized marks on or within semiconductor wafer materials, such alumina or sapphire. Laser micromachining systems can also make appropriately sized marks on or within glass, strengthened glass, and Corning Gorilla Glass™. Laser micromachining systems can also make appropriately sized marks on or within polycarbonates and acrylics. Laser micromachining systems can also make appropriately sized marks on or within aluminum, steel, and titanium.

In some embodiments, the substrate has a substrate refractive index between 1.2 and 2.5. In some embodiments, the substrate refractive index is between 1.5 and 2.2. In some embodiments, the substrate refractive index is between 1.7 and 2.0. In some embodiments, the substrate refractive index is between 1.75 and 1.85.

In general, marking may include one or more of cracking, density modification, void creation, stress fields, or re-crystallizations of a substrate 44 or its coating. In general, internal marking may include one or more of cracking, density modification, void creation, stress fields, or re-crystallizations of a core material between surfaces of the substrate 44. Internal marking can generally be performed on any substrate material that is at least partially transparent to the wavelength employed to preform the marking process.

Exemplary laser pulse parameters that may be selected to improve the reliability and repeatability of laser marking of the substrates 44 include laser type, wavelength, pulse duration, pulse repletion rate, number of pulses, pulse energy, pulse temporal shape, pulse spatial shape, and focal spot size and shape. Additional laser pulse parameters include specifying the location of the focal spot relative to the surface of the substrate 44 and directing the relative motion of the laser pulses with respect to the substrate 44.

With reference again to FIG. 1, some exemplary laser processing systems operable for marking spots 32 on or beneath a surface 104 (FIG. 3) of substrate 44 of a workpiece 46 are the ESI MM5330 micromachining system, the ESI ML5900 micromachining system and the ESI 5955 micromachining system, all manufactured by Electro Scientific Industries, Inc., Portland, Oreg. 97229.

These systems 40 typically employ a laser 50, such as a solid-state diode-pumped laser, which can be configured to emit wavelengths from about 266 nm (Ultraviolet (UV)) to about 1320 nm (infrared (IR)) at pulse repetition rates up to 50 MHz or even greater. However, these systems may be adapted by the substitution or addition of appropriate laser, laser optics, parts handling equipment, and control software to reliably and repeatably produce the selected spots 32 on or within substrates 44. These modifications permit the laser micromachining system 40 to direct laser pulses with the appropriate laser parameters to the desired locations on an appropriately positioned and held workpiece 46 at the desired rate and pitch between laser spots or pulses to create the desired spot 32 with desired color, contrast, and/or optical density.

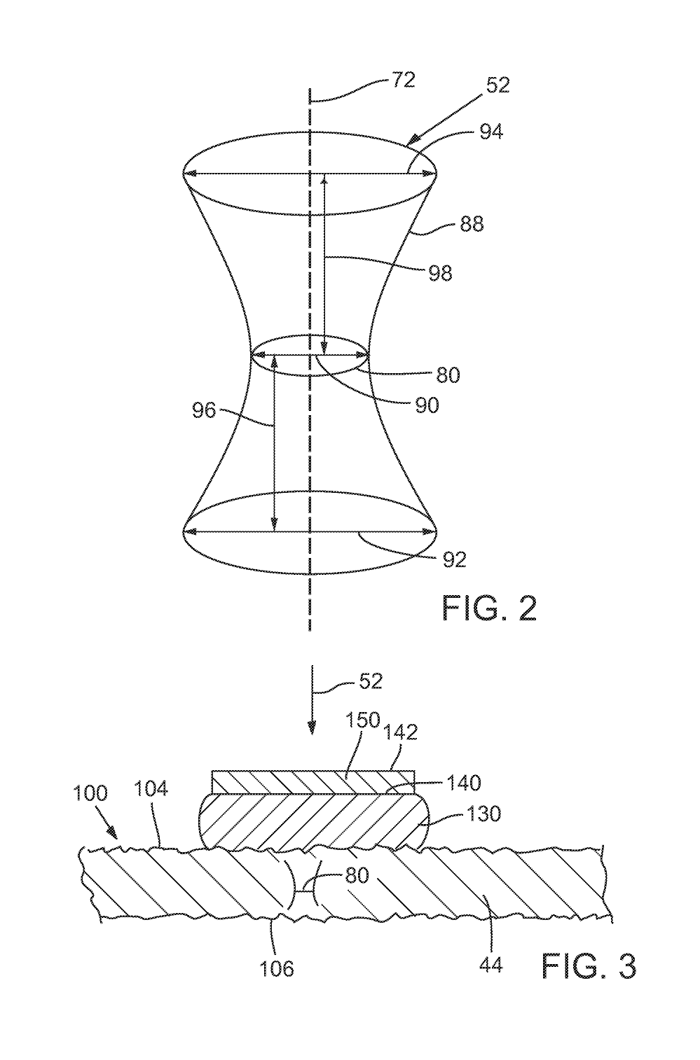

In some embodiments, the laser micromachining system 40 employs a diode-pumped Nd:YVO₄ solid-state laser 50 operating at 1064 nm wavelength, such as a model Rapid manufactured by Lumera Laser GmbH, Kaiserslautern, Germany. This laser 50 can be optionally frequency doubled using a solid-state harmonic frequency generator to reduce the wavelength to 532 nm thereby creating visible (green) laser pulses, or frequency tripled to about 355 nm or frequency quadrupled to about 266 nm thereby creating ultraviolet (UV) laser pulses. This laser 50 is rated to produce 6 Watts of continuous power and has a maximum pulse repetition rate of 1000 KHz. This laser 50 produces laser pulses 52 (FIG. 2) with duration of 1 picosecond to 1,000 nanoseconds in cooperation with controller 54.

In some embodiments, the laser micromachining system 40 employs a diode-pumped erbium-doped fiber laser with a fundamental wavelength within the range of about 1030-1550 nm. These lasers can be optionally frequency doubled using a solid-state harmonic frequency generator to reduce the wavelength to about 515 nm thereby creating visible (green) laser pulses or to about 775 nm thereby creating visible (dark red) laser pulses, for example, or frequency tripled to about 343 nm or about 517 nm, or frequency quadrupled to about 257 nm or about 387.5 nm thereby creating ultraviolet (UV) laser pulses. More generally, in some embodiments, the laser wavelength comprises a wavelength between 200 nm and 3000 nm.

These laser pulses 52 may be Gaussian or specially shaped or tailored by the laser optics 62, typically comprising one or more optical components positioned along an optical path 60, to permit desired characteristics of the spots 32. For example, a “top hat” spatial profile may be used which delivers a laser pulse 12 having an even dose of radiation over the entire spot 32 that impinges the substrate 44. Specially shaped spatial profiles such as this may be created using diffractive optical elements or other beam-shaping components. A detailed description of modifying the spatial irradiance profile of laser spots 32 can be found in U.S. Pat. No. 6,433,301 of Corey Dunsky et al., which is assigned to the assignee of this application, and which is incorporated herein by reference.

The laser pulses 52 are propagated along an optical path 60 that may also include fold mirrors 64, attenuators or pulse pickers (such as acousto-optic or electro-optic devices) 66, and feedback sensors (such as for energy, timing, or position) 68.

The laser optics 62 and other components along the optical path 60, in cooperation with a laser beam-positioning system 70 directed by the controller 54, direct a beam axis 72 of the laser pulse 52 propagating along the optical path 60 to form a laser focal spot 80 (FIG. 2) in proximity to the surface 42 of the substrate 44 at a laser spot position. The laser beam-positioning system 70 may include a laser stage 82 that is operable to move the laser 50 along an axis of travel, such as the X-axis, and a fast-positioner stage 84 to move a fast positioner (not shown) along an axis of travel, such as the Z-axis. A typical fast positioner employs a pair of galvanometer-controlled mirrors capable of quickly changing the direction of the beam axis 72 over a large field on the substrate 44. Such field is typically smaller than the field of movement provided by the workpiece stage 86, which provides movement of the workpiece 46 along one or more axes, such as the Y axis and/or the X axis.

An acousto-optic device or a deformable mirror may also be used as the fast positioner, even though these devices tend to have smaller beam deflection ranges than galvanometer mirrors. Alternatively, an acousto-optic device or a deformable mirror may be used as a high-speed positioning device in addition to galvanometer mirrors.

Additionally, the workpiece 46 may be supported by a workpiece stage 86 having motion control elements operable to position the substrate 44 with respect to the beam axis 72. The workpiece stage 86 may be operable to travel along a single axis, such as the Y-axis, or the workpiece stage 86 may be operable to travel along transverse axes, such as the X- and Y-axes. Alternatively, the workpiece stage 86 may be operable to rotate the workpiece 46, such as about a Z-axis (solely, or as well as move the workpiece 46 along the X- and Y-axes).

The controller 54 can coordinate operation of the laser beam-positioning system 70 and the workpiece stage 86 to provide compound beam-positioning capability, which facilitates the capability to mark spots 32 on or within the substrate 42 while the workpiece 46 can be in continuous relative motion to the beam axis 72. This capability is not necessary for marking the spots 32 on the substrate 42, but this capability may be desirable for increased throughput. This capability is described in U.S. Pat. No. 5,751,585 of Donald R. Cutler et al., which is assigned to the assignee of this application, and which is incorporated herein by reference.

Additional or alternative methods of beam positioning can be employed. Some additional or alternative methods of beam positioning are described in U.S. Pat. No. 6,706,999 of Spencer Barrett et al. and U.S. Pat. No. 7,019,891 of Jay Johnson, both of which are assigned to the assignee of this application, and which are incorporated herein by reference.

FIG. 2 shows a diagram of the focal spot 80 and its beam waist 90. With reference to FIG. 2, the focal spot 80 of the laser pulse 52 will have a beam waist 90 (cross-section) and laser energy distribution that are largely determined by the laser optics 62. The major spatial axis of the marking spot 32 is typically a function of the major axis of the beam waist, and the two may be the same or similar. However, the major spatial axis of the marking spot 32 may be larger than or smaller than the major axis of the beam waist 90.

The laser optics 62 can be used to control the depth of focus of the beam waist and hence the depth of the spot 32 on within the substrate 44. By controlling the depth of focus, the controller 54 can direct the laser optics 62 and the fast positioner Z-stage 84 to position the spot 32 either at or near the surface of the substrate 44 repeatably with high precision. Making marks by positioning the focal spot 80 above or below the surface 42 of the substrate 44 allows the laser beam to defocus by a specified amount and thereby increase the area illuminated by the laser pulse and decrease the laser fluence at the surface 42 (to an amount that is less than the damage threshold of the material at the surface 42). Since the geometry of the beam waist 90 is known, precisely positioning the focal spot 80 above or below or within the actual surface 42 of the substrate 44 will provide additional precision control over the major spatial axis and the fluence.

In some embodiments, such as for marking transparent materials such as sapphire, the laser fluence can be precisely controlled at the core of the substrate 44 by adjusting the location of the laser spot from being on the surface 42 of the substrate 44 to being located a precise distance within the substrate 44. With reference again to FIG. 7, the beam waist 90 is represented as a spatial energy distribution 88 of a laser pulse 52 along the beam axis 72 as measured by the full width half maximum (FWHM) method. The major axis 92 represents the laser pulse spot size on the surface 42 if the laser micromachining system 40 focuses the laser pulse 52 at a distance 96 above the surface 42. The major axis 94 represents the laser pulse spot size on the surface 42 if the laser processing system focuses the laser pulses at a distance 98 below the surface. For most embodiments where internal marking of the spots 32 is desirable, the focal spot 80 is directed to be positioned within the substrate 44 rather than above or below its surface 42. The fluence or irradiance may be employed at an amount that is lower than the ablation threshold of the substrate material except at the focal spot 80, at which the fluence or irradiance is concentrated to be above the ablation threshold of the substrate material.

In some embodiments, groups of laser pulses 52 can be employed to create a single spot 32. In particular, laser parameters may be selected to cause each laser pulse to affect an area that is smaller than the desirable size for a marking spot 32. In such cases, a plurality of laser pulses may be directed at a single location until the spot 32 reaches a desirable size (which still may be undetectable by the human eye). The group of laser pulses can be delivered in relative motion or in substantially relative stationary positions.

Laser parameters that may be advantageously employed for some embodiments include using lasers 50 with wavelengths that range from IR through UV, or particularly from about 3000 nm to about 200 nm, or more particularly from about 10.6 microns down to about 266 nm. The laser 50 may operate at 2 W, being in the range of 1 W to 100 W, or more preferably 1 W to 12 W. Pulse durations range from 1 picosecond to 1000 ns, or more preferably from about 1 picosecond to 200 ns. The laser repetition rate may be in a range from 1 KHz to 100 MHz, or more preferably from 10 KHz to 1 MHz. Laser fluence may range from about 0.1×10⁻⁶ J/cm² to 100.0 J/cm² or more particularly from 1.0×10⁻² J/cm² to 10.0 J/cm². The speed with which the beam axis 72 moves with respect to the substrate 44 being marked ranges from 1 mm/s to 10 m/s, or more preferably from 100 mm/s to 1 m/s. The pitch or spacing between adjacent rows of spots 32 on the substrate 44 may range from 1 micron to 1000 microns or more preferably from 10 microns to 100 microns. The major spatial axis of the beam waist 90 of the laser pulses 52 measured at the focal point 80 of the laser beam may range from 10 microns to 1000 microns or from 50 microns to 500 microns. Of course, the major spatial axis is preferably smaller than about 50 microns if the spot 32 is intended to be invisible. In some embodiments, the beam waist 90 of the focal point 80 is between 1 micron and 50 microns. In some embodiments, the beam waist 90 of the focal point 80 is between 1 micron and 25 microns. In some embodiments, the beam waist 90 of the focal point 80 is between 1 micron and 5 microns.

The elevation of the focal spot 80 of the laser pulses 52 with respect to the surface 42 of the substrate 44 may range from −10 mm (10 mm below the surface 42) to +10 mm (10 mm above the surface 42) or from −5 mm to +5 mm. In many embodiments for surface marking, the focal spot 80 is positioned at the surface 42 of the substrate 44.

For many embodiments of internal marking, the focal spot 80 is positioned beneath the surface 42 of the substrate 44 (between the surfaces of the substrate 44). For some embodiments of internal marking, the focal spot 80 is positioned at least 10 microns beneath the surface 42 of the substrate 44. For some embodiments of internal marking, the focal spot 80 is positioned at least 50 microns beneath the surface 42 of the substrate 44. For some embodiments of internal marking, the focal spot 80 is positioned at least 100 microns beneath the surface 42 of the substrate 44.

Applicant discovered that use of a subsurface focal spot 80 in combination with the use of picosecond lasers, which produce laser pulsewidths in the range from 1 to 1,000 picoseconds, provided a good way to reliably and repeatably create marks within some transparent semiconductor substrates, such as sapphire. In some embodiments, pulsewidths in a range from 1 to 100 ps can be employed. In some embodiments, pulsewidths in a range from 5 to 75 ps can be employed. In some embodiments, pulsewidths in a range from 10 to 50 ps can be employed. It is speculated that femtosecond laser, producing pulsewidths in the 1- to 1000-femtosecond (fs) range, could alternatively provide good results. Alternatively, pulseswidths in a range from 1 fs to 500 nanoseconds (ns) can be employed. In some embodiments, pulsewidths in a range from 500 fs to 10 ns can be employed. An advantage of using picosecond lasers, however, is that they are much less expensive, require much less maintenance, and typically have much longer operating lifetimes than existing femtosecond lasers. Nevertheless, femtosecond lasers may be preferred in some instances despite their greater costs.

Although marking can be accomplished at a variety of wavelengths as previously discussed, applicant found that IR lasers operating in the picosecond ranges provide particularly repeatable good results. Wavelengths at or near 1064 nm were particularly advantageous. An exemplary laser 50 was a Lumera 6 W laser. It will be appreciated that fiber lasers or other types of lasers could be employed.

U.S. Pat. Pub. No. 2011-0287607 of Osako et al. describes additional parameters and techniques that can be used for making marks in transparent or semi transparent wafer materials. U.S. Pat. Pub. No. 2011-0287607 is assigned to the assignee of this application, and is incorporated herein by reference. Many of the stitch-cutting and other techniques and parameters, such as those disclosed in U.S. Reissue Pat. No. RE 43,605 of O'Brien et al., can be adopted for internal marking in accordance with this disclosure. U.S. Reissue Pat. No. RE 43,605 is assigned to the assignee of this application, and is incorporated herein by reference.

Similar parameters to those disclosed herein can also be used to make visible or invisible subsurface metals or coated metals, such as anodized aluminum. Tailoring marking for anodized aluminum substrates 44 is described in detail in U.S. Pat. No. 8,379,679 and U.S. Pat. Pub. No. 2013-0208074, both of Haibin Zhang et al., both of which are assigned to the assignee of this application, and both of which are incorporated herein by reference.

FIG. 3 is a cross sectional side view of a substrate 44, such as a sapphire wafer 100, having a rough surface 104 covered by a coating material 130 and a cover 150. As previously discussed, transparent semiconductor substrate materials can be marked internally by selectively directing laser output at the substrate material. Internal marking of the substrate 44 retains the integrity of its surfaces 104 and 106, such as its water and dirt resistance. Internal marking also reduces crack propagation and other adverse effects created by surface marking. Internal marking may be achieved through a number of techniques as previously discussed. For example, laser output can be focused to have a focal spot 80 with the beam waist 90 located or concentrated between the upper and lower surfaces 104 and 106 of the substrate 44. Internal marking may include one or more of cracking, density modification, void creation, stress fields, or re-crystallizations of the core material between the surfaces.

However, applicant has noted that wafers 100 or other semiconductor substrate materials cut from ingots tend to have surfaces 104 and 106 that have rough surface texture. The ingot cutting process typically employs a diamond saw. In some embodiments, the surface roughness is greater than or equal to 3 nm. In some embodiments, the surface roughness is greater than or equal to 3 nm and smaller than or equal to 300 microns. In some embodiments, the surface roughness is greater than or equal to 3 nm and smaller than or equal to 100 microns. In some embodiments, the surface roughness is greater than or equal to 3 nm and smaller than or equal to 1 micron. In some embodiments, the surface roughness is greater than or equal to 3 nm and smaller than or equal to 100 nm. In some embodiments, the surface roughness creates a “frosting effect.” In some embodiments, the surface roughness is greater than or equal to two times the wavelength of the laser output. In some embodiments, the surface roughness is greater than or equal to four times the wavelength of the laser output.

Applicant has also noted that the surface texture of these surfaces 104 and 106 in their native states can adversely affect optical properties of the laser pulses 52 directed at the substrate 44. Moreover, applicant has also determined that substrates 44 having a surface 104 or 106 with rough texture, such as an unpolished surface, can be difficult to mark internally without causing damage to the surface 104 or 106.

Finally, applicant has determined that the adverse optical effects of the rough surfaces 104 and 106 can be mitigated by employing a coating material 130 and/or a cover 150 (positioned over the coating material) that effectively provides a flat surface to receive the pulses 52 of laser output. In some embodiments, the rough surface texture of the rough surface has a native state that causes scattering of the laser output, and the coating material reduces the scattering of the laser output that would be caused by the native state of the rough surface in the absence of the coating material. In some embodiments, the rough surface texture of the rough surface has a native state that attenuates the output power, and the coating material reduces attenuation of the output power that would be caused by the native state of the rough surface texture in the absence of the coating material. In some embodiments, the rough surface texture of the rough surface has a native state that interferes with formation of the beam waist at a predetermined size, and the coating material reduces interference with the formation of the beam waist at the predetermined size that would be caused by the native state of the rough surface texture in the absence of the coating material. In some embodiments, the rough surface texture of the rough surface has a native state that causes wavefront distortion of the laser output, and the coating material reduces the wavefront distortion of the laser output that would be caused by the native state of the rough surface in the absence of the coating material.

With reference to FIG. 3, in some embodiments the flat surface may be an upper surface 140 of the coating material 130 or the flat surface may be an upper surface 142 of the cover 150. Thus, the flat surface 142 can effectively be the flat surface for the cover 150 as well as for the coating material 130.

In some embodiments, the coating material 130 has a coating refractive index that is optically compatible with the substrate refractive index. For example, the coating refractive index may be within 2 of the refractive index of that of the substrate 44 (such as at 25 degrees Celsius). The coating refractive index may be within 1 of the refractive index of the substrate refractive index. The coating refractive index may be within 0.5 of the refractive index of the substrate refractive index. The coating refractive index may be within 0.2 of the refractive index of the substrate refractive index. The coating refractive index may be between 1.2 and 2.5. The coating refractive index may be between 1.5 and 2.2. The coating refractive index may be between 1.7 and 2.0. The coating refractive index may be between 1.75 and 1.85.

The coating material 130 may comprise a fluid, a gel, or an oil. In some embodiments, the coating material 130 may have a boiling point that is greater than 160 degrees Celsius (such as at 760 mm Hg). In some embodiments, the coating material 130 may have a boiling point that is greater than 170 degrees Celsius (such as at 760 mm Hg). In some embodiments, the coating material 130 may have a boiling point that is greater than 180 degrees Celsius (such as at 760 mm Hg). In some embodiments, the coating material 130 may have a boiling point that is lower than 210 degrees Celsius (such as at 760 mm Hg). In some embodiments, the coating material 130 may have a boiling point that is lower than 200 degrees Celsius (such as at 760 mm Hg). In some embodiments, the coating material 130 may have a boiling point that is lower than 190 degrees Celsius (such as at 760 mm Hg).

In some embodiments, the coating material may have a density of between 2 and 5 g/cc (such as at 25 degrees Celsius). In some embodiments, the coating material 130 may have a density of between 2.5 and 4 g/cc. In some embodiments, the coating material may have a density of between 3 and 3.5 g/cc. In some embodiments, the coating material 130 may have a viscosity of between 1 and 3.

In some embodiments, the coating material may have a coefficient of thermal expansion between 0.0001 and 0.0015 cc/degree C. In some embodiments, the coating material may have a coefficient of thermal expansion between 0.0003 and 0.0011 cc/degree C. In some embodiments, the coating material may have a coefficient of thermal expansion between 0.0005 and 0.0009 cc/degree C.

In some embodiments, the coating material 130 may be partly soluble in at least one of acetone, carbon tetrachloride, ethyl ether, methylene chloride, toluene, xylene, or a combination thereof. In some embodiments, the coating material 130 may be insoluble in at least one of ethanol, freon, heptane, naptha, turpentine, water, or a combination thereof. In some embodiments, the coating material 130 may be corrosive to aluminum, brass, copper, and steel.

In some embodiments, the coating material 130 may comprise methylene iodide. In some embodiments, the coating material 130 may comprise dissolved solids. In some embodiments, the coating material 130 comprises methylene iodide with dissolved solids.

In some embodiments, the coating material 130 can maintain fluidic properties during laser processing. Alternatively, the coating material 130 can be transiently affected during laser processing and return to its previous condition after cooling.

The coating material 130 may comprise a leveling composition so that the surface exposed to the laser pulses 52 is level as well as flat, thereby provide the laser pulses with a known angle of impingement with the flat surface, such as being normal to laser impingement.

In some embodiments, the amount of applied coating material 130 is sufficiently thin to avoid absorption. In some embodiments, the applied coating material 130 has a thickness between 25 microns and 2 mm. In some embodiments, the applied coating material 130 has a thickness between 50 microns and 1 mm.

In some embodiments, the coating material 130 may comprise a gem refractometer liquid. In one embodiment, the gem refractometer liquid comprises methylene iodide with dissolved solids and has: a coating refractive index of 1.81+/−005 at 25 degrees Celsius; a boiling point that is greater than 180 degrees Celsius at 760 mm Hg; a density of 3.135 g/cc at 25 degrees Celsius; and a coefficient of thermal expansion of 0.0007 cc/degree C. An exemplary gem refractometer fluid is sold by Cargille Laboratories, Inc. of Cedar Grove, N.J., USA.

The coating material 130 is preferably nonpermanently supported by or attached to, and/or easy to remove from, the rough surface after laser processing. In some embodiments, the coating material 130 can be removed or cleaned from the rough surface by acetone, carbon tetrachloride, ethyl ether, methylene chloride, toluene, xylene, or a combination thereof, or the coating material 130 can be removed or cleaned from the rough surface by water or soap and water, or the coating material 130 can be removed or cleaned from the rough surface by alcohol.

As previously discussed, the coating material 130 can be contained by a cover 150. In some embodiments, the coating material has an upper surface and wherein the cover is shaped to flatten the upper surface of the coating material. In some embodiments, the substrate core has a core thickness, and the cover 150 has a cover thickness that is shorter than the core thickness.

In some embodiments, the cover material 150 has a cover refractive index that is optically compatible with the substrate refractive index. For example, the cover refractive index may be within 2 of the refractive index of that of the substrate 44 (such as at 25 degrees Celsius). The cover refractive index may be within 1 of the refractive index of the substrate refractive index. The cover refractive index may be within 0.5 of the refractive index of the substrate refractive index. The cover refractive index may be within 0.2 of the refractive index of the substrate refractive index. The cover refractive index may be between 1.2 and 2.5. The cover refractive index may be between 1.5 and 2.2. The cover refractive index may be between 1.7 and 2.0. The cover refractive index may be between 1.75 and 1.85.

The cover 150 may be transparent to the laser wavelength. The cover 150 may comprise the substrate material. The cover 150 may comprise a smooth cover surface that is nonreflective at the wavelength. The cover 150 may comprise a glass. The cover 150 may comprise a sapphire, diamond, silicon, or plastic.

In some embodiments, the cover 150 is optically flat. In some embodiments, the cover 150 is naturally flat or polished. In some embodiments, the cover 150 has an optical grade.

In some embodiments, the cover 150 is sufficiently thin to avoid absorption and sufficiently thick to avoid fragility. In some embodiments, the cover 150 has a thickness between 25 microns and 2 mm. In some embodiments, the cover 150 has a thickness between 50 microns and 1 mm.

The foregoing is illustrative of embodiments of the invention and is not to be construed as limiting thereof. Although a few specific example embodiments have been described, those skilled in the art will readily appreciate that many modifications to the disclosed exemplary embodiments, as well as other embodiments, are possible without materially departing from the novel teachings and advantages of the invention.

Accordingly, all such modifications are intended to be included within the scope of the invention as defined in the claims. For example, skilled persons will appreciate that the subject matter of any sentence or paragraph can be combined with subject matter of some or all of the other sentences or paragraphs, except where such combinations are mutually exclusive.

It will be obvious to those having skill in the art that many changes may be made to the details of the above-described embodiments without departing from the underlying principles of the invention. The scope of the present invention should, therefore, be determined by the following claims, with equivalents of the claims to be included therein.

1. A method for laser processing a substrate having opposing first and second surfaces of substrate material and having a core of substrate material between the first and second surfaces, wherein at least one of the first and second surfaces has a rough surface with rough surface texture, and wherein the core of substrate material has a substrate refractive index, the method comprising:
providing the substrate, wherein a coating material has been applied to the rough surface, and wherein the coating material has a coating refractive index that is optically compatible with the substrate refractive index of the substrate material;
generating laser output having laser processing parameters suitable for marking the core of the substrate material without damaging the rough surface after passing through the coating material, wherein the laser processing parameters include a laser wavelength;
focusing laser pulses of the laser output to have a minimum beam waist at a focal point; and
directing the laser output through the coating material and through the rough surface so that the focal point of the laser pulses is positioned within the core of the substrate material to mark the core of the substrate without damaging the rough surface, wherein the coating material is at least partly optically transmissive to the laser wavelength.

2. The method of claim 1, wherein the substrate is at least partly optically transmissive to the laser wavelength.

3. The method of claim 1, wherein the substrate comprises a sapphire wafer, a diamond wafer, or a silicon wafer.

4. The method of claim 1, wherein the coating material comprises a fluid, a gel, or an oil.

5. The method of claim 1, wherein the coating material has a boiling point that is greater than 180 degrees Celsius at 760 mm Hg.

6. The method of claim 1, wherein the coating refractive index is within 2 of the refractive index of the substrate refractive index at 25 degrees Celsius.

7. The method of claim 1, wherein the coating refractive index is within 1 of the refractive index of the substrate refractive index.

8. The method of claim 1, wherein the coating refractive index is within 0.5 of the refractive index of the substrate refractive index.

9. The method of claim 1, wherein the coating refractive index is within 0.2 of the refractive index of the substrate refractive index.

10. The method of claim 1, wherein the coating refractive index is between 1.2 and 2.5.

11. The method of claim 1, wherein the coating refractive index is between 1.75 and 1.85.

12. The method of claim 1, wherein the coating material has a density of between 2 and 5 g/cc at 25 degrees Celsius.

13. The method of claim 1, wherein the coating material comprises methylene iodide.

14. The method of claim 1, wherein the coating material comprises gem refractometer liquid.

15. The method of claim 1, wherein the coating material maintains fluidic properties during laser processing.

16. The method of claim 1, wherein the coating material comprises a leveling composition.

17. The method of claim 1, wherein the coating material is nonpermanently supported by the substrate and from the rough surface after laser processing.

18. The method of claim 1, wherein a cover has been placed over the coating after the step applying a coating material before the step of directing the laser output and wherein the cover comprises a sapphire, diamond, silicon, glass, or plastic, wherein the cover has a cover refractive index that is within 2 of the refractive index of the substrate refractive index at 25 degrees Celsius, wherein the cover has a cover refractive index that is between 1.2 and 2.5.

19. The method of claim 1, wherein the rough surface texture of the rough surface has a native state that causes scattering of the laser output, and wherein the coating material reduces the scattering of the laser output that would be caused by the native state of the rough surface in the absence of the coating material.

20. The method of claim 1, wherein the laser processing parameters include output power, and wherein the rough surface texture of the rough surface has a native state that attenuates the output power, and wherein the coating material reduces attenuation of the output power that would be caused by the native state of the rough surface texture in the absence of the coating material.

21. The method of claim 1, wherein the rough surface texture of the rough surface has a native state that interferes with formation of the beam waist at a predetermined size, and wherein the coating material reduces interference with the formation of the beam waist at the predetermined size that would be caused by the native state of the rough surface texture in the absence of the coating material.

22. The method of claim 1, wherein the rough surface texture of the rough surface has a native state that causes wavefront distortion of the laser output, and wherein the coating material reduces the wavefront distortion of the laser output that would be caused by the native state of the rough surface in the absence of the coating material.

23. The method of claim 1, wherein the coating material can be cleaned from the rough surface by one of acetone, carbon tetrachloride, ethyl ether, methylene chloride, toluene, xylene, alcohol, or water, or a combination thereof.

24. A method for laser processing a substrate having opposing first and second surfaces of substrate material and having a core of substrate material between the first and second surfaces, wherein at least one of the first and second surfaces has a rough surface with rough surface texture, and wherein the core of substrate material has a substrate refractive index, the method comprising:
applying a coating material to the rough surface, wherein the coating material has a coating refractive index that is optically compatible with the substrate refractive index of the substrate material;
generating laser output having laser processing parameters suitable for marking the core of the substrate material without damaging the rough surface after passing through the coating material, wherein the laser processing parameters include a laser wavelength;
focusing laser pulses of the laser output to have a minimum beam waist at a focal point; and
directing the laser output through the coating material and through the rough surface so that the focal point of the laser pulses is positioned within the core of the substrate material to mark the core of the substrate without damaging the rough surface, wherein the coating material is at least partly optically transmissive to the laser wavelength.

25. A workpiece ready for processing by a laser at a laser wavelength, comprising:
a substrate having opposing first and second surfaces of substrate material and having a core of substrate material between the first and second surfaces, wherein at least one of the first and second surfaces has a rough surface with rough surface texture, wherein the core of substrate material has a substrate refractive index, wherein the substrate comprises a wafer material, and wherein the substrate is at least partly transmissive to the laser wavelength; and
a coating material nonpermanently supported by the rough surface of the substrate, wherein the coating material comprises a fluid, gel, or oil, wherein the coating material has a coating refractive index that is within 0.5 of the substrate refractive index, wherein the coating refractive index is between 1.5 and 2.5, and wherein the coating material is at least partly transmissive to the laser wavelength.
